(19) United States
(12) Patent Application Publication
(10) Pub. No.: US 2026/0332549 A1
(43) Pub. Date: Oct. 22, 2026

(54) SMART CALL-RANKING AND NOTIFICATION SYSTEM

(71) Applicant: International Business Machines Corporation, Armonk, NY (US)

(72) Inventors: Jacob Thomas Covell, New York, NY (US); Alvin Zhang, Somerville, MA (US); Sam Selim Beyda, New York, NY (US); Hugo Almeida, Flanders, NJ (US); Thomas Jefferson Sandridge, Tampa, FL (US)

(21) Appl. No.: 19/180,275

(22) Filed: Apr. 16, 2025

(51) Int. Cl. H04L 51/224; H04L 65/403

(52) U.S. Cl. CPC H04L 51/224; H04L 65/403

(57) ABSTRACT

One or more systems, devices, computer program products and/or computer-implemented methods of use provided herein relate to a smart call-ranking and notification system. For example, a system can comprise a memory that can store computer-executable components. The system can further comprise a processor that can execute the computer-executable components stored in the memory, where the computer-executable components can comprise a computation component that can compute a current state criticality score and a future state criticality score, where the current state criticality score can be associated with a first virtual meeting and the future state criticality score can be associated with a second virtual meeting. The computer-executable components can further comprise a notification delivery component that can generate, based on the current state criticality score and the future state criticality score, a notification that can alert a user participating in the first virtual meeting about the second virtual meeting.

### BACKGROUND

The subject disclosure relates to telecommunication technology and, more specifically, to a smart call-ranking and notification system.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable a smart call-ranking and notification system are discussed.

According to an embodiment, a system is provided. The system can comprise a memory that can store computer-executable components. The system can further comprise a processor that can execute the computer-executable components stored in the memory, where the computer-executable components can comprise a computation component that can compute a current state criticality score and a future state criticality score, where the current state criticality score can be associated with a first virtual meeting and the future state criticality score can be associated with a second virtual meeting. The computer-executable components can further comprise a notification delivery component that can generate, based on the current state criticality score and the future state criticality score, a notification that can alert a user participating in the first virtual meeting about the second virtual meeting.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can interpret the criticality of a virtual meeting and generate an optimal notification to a participant of the virtual meeting, in accordance with one or more embodiments described herein.

FIG. 2 illustrates another block diagram of an example, non-limiting system that can interpret the criticality of a virtual meeting and generate an optimal notification to a participant of the virtual meeting, in accordance with one or more embodiments described herein.

FIG. 3 illustrates a flow diagram of an example, non-limiting method that can interpret the criticality of a virtual meeting and generate an optimal notification to a participant of the virtual meeting, in accordance with one or more embodiments described herein.

FIG. 4 illustrates a flow diagram of an example, non-limiting method that can employ feedback, based on the responses of a participant of a virtual meeting to a notification, to more accurately interpret the criticality of a future virtual meeting, in accordance with one or more embodiments described herein.

FIG. 5 illustrates a flow diagram of an example, non-limiting method that can interpret the criticality of a virtual meeting and generate an optimal notification to a participant of the virtual meeting, in accordance with one or more embodiments described herein.

FIG. 6 illustrates a flow diagram of an example, non-limiting method that can interpret the priority of a virtual meeting and initiate a step-up notification, in accordance with one or more embodiments described herein.

FIG. 7 illustrates a flow diagram of an example, non-limiting method that can interpret the criticality of a virtual meeting and generate a meeting reminder, in accordance with one or more embodiments described herein.

FIG. 8 illustrates a flow diagram of an example, non-limiting method that can employ feedback to update weight allocations employable to compute respective criticality scores for respective virtual meetings, in accordance with one or more embodiments described herein.

FIG. 9 illustrates a flow diagram of an example, non-limiting method that can interpret the criticality of a virtual meeting and generate an optimal notification to a participant of the virtual meeting, in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

The videoconferencing (or web conferencing) industry experienced an explosive growth during the Covid-19 spread and is poised to remain a focal point of the global business landscape moving forward. From 2005-2019, the global remote labor force increased by 173%. Some studies have suggested that by 2026, nearly 28% of the American labor force will work fully remotely. These statistics combined with advances in technology, collaboration, and communication tools have accelerated the need for robust videoconferencing solutions, and the videoconferencing industry is anticipated to reach approximately $20.2 billion by 2030. While videoconferencing technology has enabled virtual meetings to occur seamlessly, many workers are still adapting to this new reality. The ease of creating digital meetings has led to an overall influx of new meeting invitations, a situation that has caused workers to experience videoconferencing fatigue and meeting overload. Often faced with back-to-back meetings, long sessions, and recurring meetings, workers have struggled to prioritize meetings in a fashion that conserves energy and increases their overall productivity.

Although existing videoconferencing solutions account for factors such as the context of a virtual meeting, adding context to virtual meeting notifications, ranking virtual meeting notifications, and so on, such solutions often do not compare the contexts of different meetings, analyze user engagement in virtual conferences, analyze user data and device data associated with virtual conferences, or address back-to-back virtual meetings. Thus, solutions to assist end entities (e.g., hardware, software, machines, artificial intelligence (AI), neural networks and/or users) in managing virtual meetings more efficiently can be desirable.

Various embodiments of the present disclosure can be implemented to produce a solution to these problems. Embodiments described herein include systems, computer-implemented methods, and computer program products that can employ sensory data and device data to dynamically prioritize virtual meetings and adjust notification delivery methods to assist an end entity (e.g., hardware, software, machine, AI, neural network and/or user) in seamlessly transitioning from one virtual meeting to another virtual meeting. The embodiments of the present disclosure can cognitively interpret the priority of a virtual meeting to identify an optimal notification delivery system/method to alert an end entity (e.g., hardware, software, machine, AI, neural network and/or user) participating in the virtual meeting about upcoming/future virtual meetings. For example, by analyzing data comprising the context of a virtual meeting, user activity, and user engagement in virtual meetings, the embodiments of the present disclosure can capture the objective priorities of each virtual meeting and employ the data to generate meeting-specific notifications in a manner that can replicate the choices/virtual meeting preferences of attendees of virtual meetings.

Specifically, in various embodiments, a smart call-ranking and notification model is provided that can assist an end entity (e.g., hardware, software, machine, AI, neural network and/or user) in seamlessly transitioning between virtual meetings (e.g., virtual conferences or web conferences). The smart call-ranking and notification model can be an automated, learning-based system that can aggregate and analyze, before and during virtual meetings, voice data, text data, web camera (webcam) data, application data and/or other relevant data associated with the virtual meetings and an end entity (e.g., hardware, software, machine, AI, neural network and/or user) scheduled to participate in the virtual meetings, to determine optimal notifications and actions to alert the end entity (e.g., hardware, software, machine, AI, neural network and/or user) about future virtual meetings.

For example, in one or more embodiments, the smart call-ranking and notification model can employ a computation component that can parse meeting data, wherein the meeting data can comprise email data, calendar data, virtual meeting attendance records and recordings of prior virtual meetings associated with an end entity (e.g., hardware, software, machine, AI, neural network and/or user) engaged in a virtual meeting. Upon parsing the meeting data, the computation component can identify one or more upcoming virtual meetings that can be imminent for the end entity (e.g., hardware, software, machine, AI, neural network and/or user) on a certain day and time and determine respective criticality scores for respective virtual meetings of the one or more upcoming virtual meetings. For example, the computation component can compute, via an NLU classification component and a user engagement component, a current state criticality score for the virtual meeting and a future state criticality score for an upcoming virtual meeting.

In one or more embodiments, the smart call-ranking and notification model can further employ a notification delivery component that can identify, based on the respective criticality scores, one or more notifications (e.g., one or more optimal notifications delivery methods) to alert the end entity (e.g., hardware, software, machine, AI, neural network and/or user) about an upcoming virtual meeting. In one or more embodiments, the notification delivery component can further determine a notification from the one or more notifications, wherein the notification can be based on the current status (e.g., level of engagement in an on-going virtual meeting, etc.) of the end entity (e.g., hardware, software, machine, AI, neural network and/or user) and a comparison of the current state criticality score with the future state criticality score. In one or more embodiments, the notification delivery component can further deliver the notification to the end entity (e.g., hardware, software, machine, AI, neural network and/or user) via a non-obtrusive notification or a step-up notification.

In one or more embodiments, the notification delivery component can further determine whether the end entity (e.g., hardware, software, machine, AI, neural network and/or user) accepts the notification, that is, whether the end entity (e.g., hardware, software, machine, AI, neural network and/or user) transitions from the virtual meeting to the upcoming virtual meeting based on the notification. In response to the end entity (e.g., hardware, software, machine, AI, neural network and/or user) transitioning to the upcoming virtual meeting based on the notification, the notification delivery component can automatically transfer the end entity (e.g., hardware, software, machine, AI, neural network and/or user) to the upcoming virtual meeting. On the contrary, in response to the end entity (e.g., hardware, software, machine, AI, neural network and/or user) not transitioning to the upcoming virtual meeting based on the notification and continuing to participate in the existing virtual meeting, the notification delivery component can inform participants (e.g., attendees) of the upcoming virtual meeting about the meeting conflict or a delay from the end entity (e.g., hardware, software, machine, AI, neural network and/or user) in joining the upcoming virtual meeting.

In one or more embodiments, the smart call-ranking and notification model can further employ a feedback component that can record one or more subsequent actions of the end entity (e.g., hardware, software, machine, AI, neural network and/or user) as feedback, wherein the feedback can be recorded as a positive feedback if the end entity (e.g., hardware, software, machine, AI, neural network and/or user) transitions to the upcoming virtual meeting, and wherein the feedback can be recorded as negative feedback if the end entity (e.g., hardware, software, machine, AI, neural network and/or user) does not transition to the upcoming virtual meeting.

In one or more embodiments, the feedback component can update (e.g., readjust or reinforce), based on the feedback, the weight allocations employable to compute the respective criticality scores. In one or more embodiments, the computation component can employ the updated weight allocations to compute more accurate respective criticality scores for future virtual meetings.

It should be appreciated that paragraphs [0020]-[0026] provide a brief description of the embodiments of the present disclosure, and the embodiments of the present disclosure are described in greater detail with reference to the figures.

The embodiments of the present disclosure can assist end entities (e.g., hardware, software, machines, AI, neural networks and/or users) in managing virtual meetings more efficiently as compared to existing videoconferencing solutions. For example, users can avoid debating upon which virtual meeting to attend from a group of simultaneous or overlapping virtual meetings. Additionally, notifications that are easily visible can enable smoother meeting transitions for users, and users can gain greater insights into the priorities of differing virtual meetings and their engagement within differing virtual meetings. Ultimately, the embodiments of the present disclosure can alleviate some of the stress inherent in videoconferencing by utilizing cognitive user engagement tools in a manner that can transform the end entity experience in the age of virtual meetings.

An existing method in the art focuses on adding context to virtual meeting notifications in order to rank the virtual meeting notifications based on a probability of interaction. However, contrary to embodiments of the present disclosure, this existing method does not employ criticality scores (e.g., current state criticality scores and future state criticality scores) to determine an optimal delivery method for a notification and does not employ a learning-based system that can incorporate user data and device data to generate optimal notifications for improved videoconferencing experiences.

Another existing method in the art analyzes the context associated with a user's current environment and virtual environment. However, contrary to embodiments of the present disclosure, this existing method does not address scenarios involving back-to-back virtual meetings, does not analyze a current context of a virtual meeting against the context of a future meeting, does not employ an NLU classification component that can be employed to generate criticality scores, does not analyze user engagement in virtual sessions, email invites, audiences in virtual meetings, etc., does not compute criticality scores and does not include a feature to allow a user to automatically switch from one virtual meeting to another.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

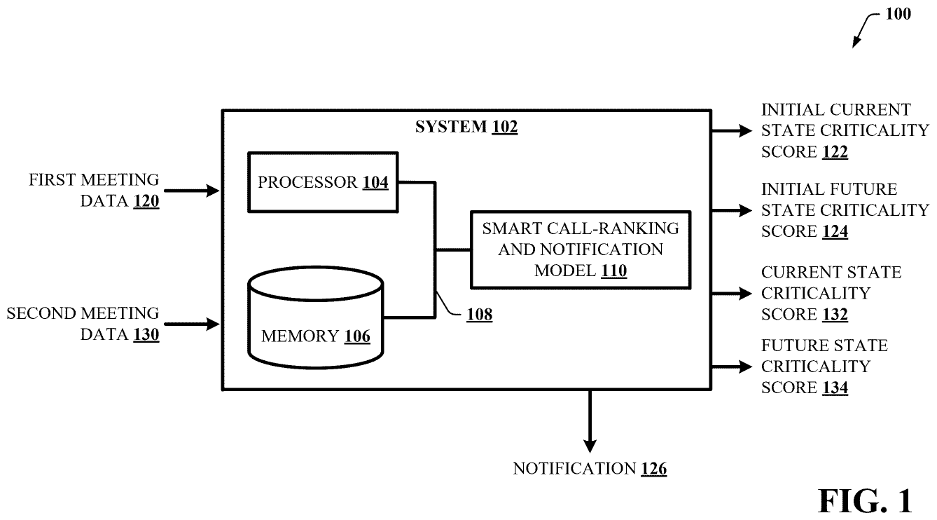

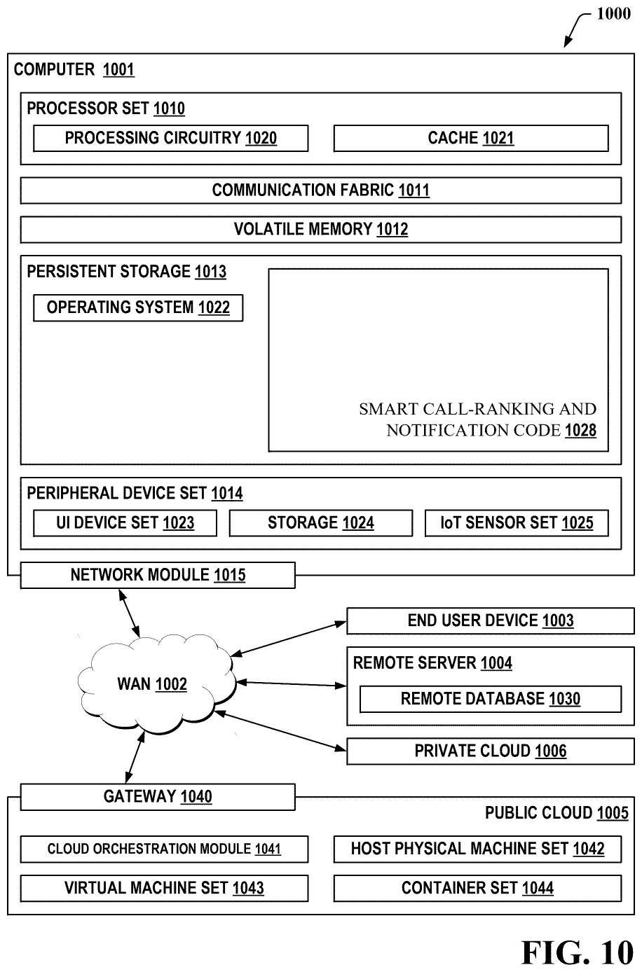

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, non-limiting system 100 can be associated with, such as accessible via, a computing environment 1000 described below with reference to FIG. 10, such that aspects of processing can be distributed between non-limiting system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can interpret the criticality of a virtual meeting and generate an optimal notification to a participant of the virtual meeting, in accordance with one or more embodiments described herein.

Non-limiting system 100 and/or components of non-limiting system 100 can be employed to use hardware and/or software to solve problems that are highly technical in nature (e.g., related to telecommunication technology, call-ranking and notifications, etc.), that are not abstract and that cannot be performed as a set of mental acts by a human. Further, some of the processes performed may be performed by specialized computers for carrying out defined tasks related to a smart call-ranking and notification system. Non-limiting system 100 and/or components of non-limiting system 100 can be employed to solve new problems that arise through advancements in technologies mentioned above and/or the like. Non-limiting system 100 can provide technical improvements to telecommunication system by improving the efficiencies of virtual meetings and reducing delays involved in transitioning between virtual meetings. Additionally, non-limiting system 100 can expand the capabilities of a company's AI portfolio, increase a company's exposure to virtual conferencing/virtual-work spaces, and expand potential partnerships between technology providers and providers of virtual conferencing solutions such as Zoom®, Microsoft®, etc.

In one or more embodiments, non-limiting system 100 can comprise system 102. Discussion turns briefly to processor 104, memory 106 and bus 108 of system 102. For example, in one or more embodiments, system 102 can comprise processor 104 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 102 can further comprise a computer-readable memory (e.g., memory 106) that can be operably connected to processor 104. Memory 106 can store computer-executable instructions that, upon execution by processor 104, can cause processor 104 and/or one or more other components of system 102 (e.g., smart call-ranking and notification model 110, computation component 202, notification delivery component 204, natural language understanding (NLU) classification component 206, user engagement component 208 and/or feedback component 210) to perform one or more actions. In one or more embodiments, memory 106 can store computer-executable components (e.g., smart call-ranking and notification model 110, computation component 202, notification delivery component 204, NLU classification component 206, user engagement component 208 and/or feedback component 210). In one or more embodiments, one or more of the components of system 102 can reside in the cloud, and/or can reside locally in a local computing environment (e.g., at a specified location(s)).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network.

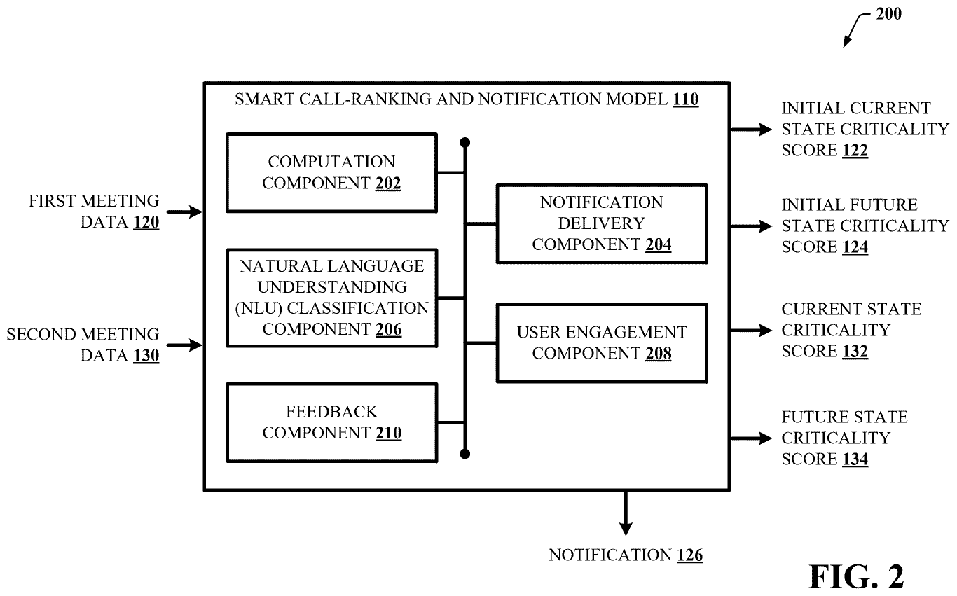

In one or more embodiments, system 102 can comprise smart call-ranking and notification model 110. Smart call-ranking and notification model 110 can comprise computation component 202, notification delivery component 204, NLU classification component 206, user engagement component 208 and feedback component 210, as illustrated in FIG. 2.

In one or more embodiments, smart call-ranking and notification model 110 can be an automated, learning-based system that can aggregate and analyze voice data, text data, data from web cameras (i.e., webcam data) and application data, before and during virtual meetings, to determine the optimal notifications (e.g., notification delivery methods and actions) to alert a participant of a virtual meeting about an upcoming virtual meeting. For example, an end entity (e.g., hardware, software, machine, AI, neural network and/or user) can be scheduled to participate in at least two virtual meetings comprising a first virtual meeting and a second virtual meeting, wherein the second virtual meeting can be scheduled to begin prior to completion of the first virtual meeting or immediately after completion of the first virtual meeting. For example, the first virtual meeting can be scheduled on a given Monday from 8:00 AM to 9:00 AM in the Eastern Standard Time (EST) time zone, and the second virtual meeting can be scheduled from 8:50 AM to 9:30 AM or from 9:10 AM to 9:30 AM in the EST time zone. In one or more embodiments, computation component 202 can compute current state criticality score 132 and future state criticality score 134, wherein current state criticality score 132 can be associated with the first virtual meeting, and wherein future state criticality score 134 can be associated with the second virtual meeting.

In one or more embodiments, computation component 202 can employ NLU classification component 206 to compute current state criticality score 132 and future state criticality score 134. For example, NLU classification component 206 can access first meeting data 120 comprising historical meeting data (e.g., virtual meeting attendance records, recordings of prior virtual meetings, etc.), future meeting data, email data, and calendar data associated with the end entity (e.g., hardware, software, machine, AI, neural network and/or user). Thereafter, NLU classification component 206 can analyze first meeting data 120. Based on analysis of first meeting data 120, NLU classification component 206 can compute initial current state criticality score 122 and initial future state criticality score 124, wherein initial current state criticality score 122 can be associated with the first virtual meeting, and wherein initial future state criticality score 124 can be associated with the second virtual meeting. In one or more embodiments, initial current state criticality score 122 and initial future state criticality score 124 can be scores on a scale from zero (0) to 100 or on another suitable scale. Additionally, initial current state criticality score 122 can indicate the priority (based on first meeting data 120) of the first virtual meeting for the end entity (e.g., hardware, software, machine, AI, neural network and/or user), and initial future state criticality score 124 can indicate the priority (based on first meeting data 120) of the second virtual meeting to the end entity (e.g., hardware, software, machine, AI, neural network and/or user). For example, initial current state criticality score 122 can be 25 and initial future state criticality score 124 can be 50, indicating that the second virtual meeting has higher priority than the first virtual meeting for the end entity (e.g., hardware, software, machine, AI, neural network and/or user). In general, a higher criticality score (i.e., initial current state criticality score 122 or initial future state criticality score 124) for a virtual meeting can indicate that the virtual meeting (e.g., the first virtual meeting or the second virtual meeting) has greater priority as compared to a virtual meeting with a lower criticality score.

In one or more embodiments, NLU classification component 206 can employ natural language understanding (NLU) to compute current state criticality score 132 and future state criticality score 134. NLU is a branch AI that focuses on enabling machines and software to understand and interpret human language. It involves processing text or speech to extract meaning, identify intent, recognize entities, and analyze sentiment.

In an embodiment, computation component 202 can automatically assign initial current state criticality score 122 and initial future state criticality score 124, and NLU classification component 206 can recompute initial current state criticality score 122 and initial future state criticality score 124 based on analysis of first meeting data 120. For example, the first virtual meeting and the second virtual meeting can be two meetings within a series of virtual meetings that the end entity (e.g., hardware, software, machine, AI, neural network and/or user) can be scheduled to attend, and computation component 202 can assign a score of 50 to each virtual meeting comprised within the series of virtual meetings. Thereafter, during analysis of the respective virtual meetings comprised in the series of virtual meetings, NLU classification component 206 can recompute (e.g., increase/decrease/maintain) the scores for the respective virtual meetings. For example, NLU classification component 206 can decrease initial current state criticality score 122 from 50 to 25 and maintain initial future state criticality score 124 at 50.

In one or more embodiments, computation component 202 can further employ user engagement component 208 to compute current state criticality score 132 and future state criticality score 134. For example, user engagement component 208 can access second meeting data 130 comprising the historical meeting data (e.g., virtual meeting attendance records, recordings of prior virtual meetings etc.), audio data, visual data and user interface (UI) data associated with the end entity (e.g., hardware, software, machine, AI, neural network and/or user). Thereafter, user engagement component 208 can analyze second meeting data 130. Based on analysis of second meeting data 130, user engagement component 208 can update initial current state criticality score 122 and initial future state criticality score 124, wherein updating initial current state criticality score 122 can generate current state criticality score 132, and wherein updating initial future state criticality score 124 can generate future state criticality score 134. For example, user engagement component 208 can increase initial current state criticality score 122 from 25 to 35 and increase initial future state criticality score 124 from 50 to 55, thereby emphasizing that the second virtual meeting holds greater priority that the first virtual meeting for the end entity (e.g., hardware, software, machine, AI, neural network and/or user). Alternatively, user engagement component 208 can increase initial current state criticality score 122 from 25 to 45 and decrease initial future state criticality score 124 from 50 to 40, thereby suggesting that the first virtual meeting holds greater priority that the second virtual meeting for the end entity (e.g., hardware, software, machine, AI, neural network and/or user). The updated increase initial current state criticality score 122 can represent current state criticality score 132, and the updated initial future state criticality score 124 can represent future state criticality score 134. In general, a higher criticality score (i.e., current state criticality score 132 or future state criticality score 134) for a virtual meeting can indicate that the virtual meeting (e.g., the first virtual meeting or the second virtual meeting) has greater priority as compared to a virtual meeting with a lower criticality score.

In one or more embodiments, user engagement component 208 can compute, based on second meeting data 130, a second current state criticality score and a second future state criticality score, wherein the second current state criticality score can be associated with the first virtual meeting, and wherein the second future state criticality score can be associated with the second virtual meeting. For example, the second current state criticality score can be indicative of the priority (based on second meeting data 130) of the first virtual meeting for the end entity (e.g., hardware, software, machine, AI, neural network and/or user), and the second future state criticality score can be indicative of the priority (based on second meeting data 130) of the second virtual meeting for the end entity (e.g., hardware, software, machine, AI, neural network and/or user). In one or more embodiments, computation component 202 can combine initial current state criticality score 122 with the second current state criticality score and generate current state criticality score 132, and computation component 202 can combine initial future state criticality score 124 with the second future state criticality score and generate future state criticality score 134.

In one or more embodiments, NLU classification component 206 can compute initial current state criticality score 122 by employing priority weighting associated with the first virtual meeting, and NLU classification component 206 can compute initial future state criticality score 124 by employing priority weighting associated with the second virtual meeting. Likewise, user engagement component 208 can update initial current state criticality score 122 by employing priority weighting in connection with the first virtual meeting to generate current state criticality score 132, and user engagement component 208 can update initial future state criticality score 124 by employing priority weighting in connection with the second virtual meeting to generate future state criticality score 134. Priority weighting can be employed by a software component (e.g., NLU classification component 206 or user engagement component 208) to generate respective scores for respective virtual meetings by evaluating criteria such as user participation, user sentiment, etc. For example, the software component can assign/allocate a specific weight (e.g., a weight allocation) to each criterion based on the value/priority of the criterion while ensuring that the total weight for all criteria equals to one (1). The software component (e.g., NLU classification component 206 or user engagement component 208) can then collect and normalize data for both virtual meetings, convert the data to a standardized scale, multiply each normalized score by its corresponding weight and sum the results to produce a final score for the respective virtual meetings. Additionally, weight allocations can be adjusted by the software component (e.g., NLU classification component 206 or user engagement component 208) based on factors like meeting objectives or participant roles to ensure accurate comparisons.

In one or more embodiments, smart call-ranking and notification model 110 can comprise a dynamic notification functionality. For example, in one or more embodiments, notification delivery component 204 can generate, based on current state criticality score 132 and future state criticality score 134, a notification (i.e., notification 126) that can alert the end entity (e.g., hardware, software, machine, AI, neural network and/or user) participating in the first virtual meeting about the second virtual meeting. In one or more embodiments, notification delivery component 204 can be a learning-based notification delivery module, and notification 126 can represent an optimal notification delivery method or alert that can be determined by notification delivery component 204 based on current state criticality score 132 and future state criticality score 134. For example, in one or more embodiments, notification delivery component 204 can compare current state criticality score 132 with future state criticality score 134. If current state criticality score 132 is greater than future state criticality score 134 (current state criticality score 132>future state criticality score 134), notification delivery component 204 can generate a meeting reminder, wherein the meeting reminder can inform the end entity (e.g., hardware, software, machine, AI, neural network and/or user) about the second virtual meeting. If current state criticality score 132 is less than future state criticality score 134 (current state criticality score 132<future state criticality score 134), notification delivery component 204 can initiate a step-up notification, wherein the step-up notification can allow the end entity (e.g., hardware, software, machine, AI, neural network and/or user) to accept or decline an automatic transition from the first virtual meeting to the second virtual meeting. In one or more embodiments, notification delivery component 204 can identify one or more notifications (e.g., one or more optimal notification delivery methods) by comparing current state criticality score 132 with future state criticality score 134, and notification delivery component 204 can select notification 126 from the one or more notifications.

In one or more embodiments, the meeting reminder can comprise a non-obtrusive meeting reminder (e.g., a pop-up on the corner of a desktop screen, a phone vibration, etc.). For example, the meeting reminder can comprise a push notification sent to a secondary device associated with the end entity (e.g., hardware, software, machine, AI, neural network and/or user) by notification delivery component 204. In one or more embodiments, the step-up notification can comprise a more pronounced method of alerting (e.g., by automatically transferring a user from the first virtual meeting to the second virtual meeting, initiating a phone call or sending a text message reminder about the second virtual meeting to the user, generating a full-screen pop-up notification, etc.) the end entity (e.g., hardware, software, machine, AI, neural network and/or user). For example, the step-up notification can be a message such as “This meeting will be transferred in 3 . . . 2 . . . 1 . . . ,” that can be displayed by notification delivery component 204 on the screen of a device (e.g., desktop computer, a laptop, a smartphone, etc.) employed by the end entity (e.g., hardware, software, machine, AI, neural network and/or user) to participate in the first virtual meeting.

Thus, notification 126 can be a meeting reminder or a step-up notification, and notification 126 can be employed by the end entity (e.g., hardware, software, machine, AI, neural network and/or user) to determine whether to prioritize the second virtual meeting over the first virtual meeting. For example, in a scenario wherein the second virtual meeting is scheduled to begin prior to completion of the first virtual meeting, notification 126 can alert the end entity (e.g., hardware, software, machine, AI, neural network and/or user) that the second virtual meeting is about to commence within a defined time duration (e.g. within 10 minutes, 15 minutes, etc.), and the end entity (e.g., hardware, software, machine, AI, neural network and/or user) can choose to exit the first virtual meeting to join the second virtual meeting or continue participating in the first virtual meeting at the expense of being late to the second virtual meeting.

In one or more embodiments, notification 126 can be a step-up notification, and feedback component 210 can update current state criticality score 132 and future state criticality score 134 based on whether the end entity (e.g., hardware, software, machine, AI, neural network and/or user) accepts or declines the automatic transition. For example, feedback component 210 can record feedback within notification delivery component 204 (i.e., communicate the feedback to notification delivery component 204), wherein the feedback can be recorded as a positive feedback if the end entity (e.g., hardware, software, machine, AI, neural network and/or user) accepts the automatic transition, or the feedback can be recorded as a negative feedback if the end entity (e.g., hardware, software, machine, AI, neural network and/or user) declines the automatic transition. Based on the feedback, feedback component 210 can update (e.g., reinforce or readjust) respective weight allocations employable by computation component 202 to compute current state criticality score 132 and future state criticality score 134. In one or more embodiments, computation component 202 can employ the updated respective weight allocations to more accurately compute current state criticality score 132 and future state criticality score 134 for future virtual meetings.

In one or more embodiments, to update (e.g., reinforce or readjust) respective weight allocations employable by computation component 202 to compute current state criticality score 132 and future state criticality score 134, feedback component 210 can analyze the feedback by employing machine learning models (e.g., to detect patterns, trends, etc.) and employ weighting algorithms (or weight adjustment algorithms) that can evaluate the factors having the most positive or negative impact. Weight adjustment algorithms can adjust weight allocations by employing reinforcement learning or gradient descent optimization. In one or more embodiments, feedback component 210 can continuously update the weight allocations based on new feedback and implement a feedback loop wherein computation component 202 can learn over time.

In one or more embodiments, notification delivery component 204 can notify attendees of the first virtual meeting, in response to the end entity (e.g., hardware, software, machine, AI, neural network and/or user) accepting the automatic transition, that the end entity (e.g., hardware, software, machine, AI, neural network and/or user) has exited from the first virtual meeting. In one or more embodiments, notification delivery component 204 can notify attendees of the second virtual meeting, in response to the end entity (e.g., hardware, software, machine, AI, neural network and/or user) declining the automatic transition, that the end entity (e.g., hardware, software, machine, AI, neural network and/or user) is expected to be late to the second virtual meeting.

Likewise, in one or more embodiments, notification 126 can be a meeting reminder, and feedback component 210 can update current state criticality score 132 and future state criticality score 134 based on whether the end entity (e.g., hardware, software, machine, AI, neural network and/or user) transitions from the first virtual meeting to the second virtual meeting upon being alerted via the meeting reminder. For example, feedback component 210 can record feedback within notification delivery component 204 (i.e., communicate the feedback to notification delivery component 204), wherein the feedback can be recorded as a positive feedback if the end entity (e.g., hardware, software, machine, AI, neural network and/or user) transitions from the first virtual meeting to the second virtual meeting, or the feedback can be recorded as a negative feedback if the end entity (e.g., hardware, software, machine, AI, neural network and/or user) does not transition from the first virtual meeting to the second virtual meeting. Based on the feedback, feedback component 210 can update (e.g., reinforce or readjust) respective weight allocations employable by computation component 202 to compute current state criticality score 132 and the future state criticality score 134. For example, computation component 202 can employ the updated respective weight allocations to more accurately compute current state criticality score 132 and future state criticality score 134 for future virtual meetings.

In one or more embodiments, notification delivery component 204 can notify attendees of the first virtual meeting, in response to the end entity (e.g., hardware, software, machine, AI, neural network and/or user) transitioning from the first virtual meeting to the second virtual meeting, that the end entity (e.g., hardware, software, machine, AI, neural network and/or user) has exited from the first virtual meeting. In one or more embodiments, notification delivery component 204 can notify attendees of the second virtual meeting, in response to the end entity (e.g., hardware, software, machine, AI, neural network and/or user) choosing not to transition from the first virtual meeting to the second virtual meeting, that the end entity (e.g., hardware, software, machine, AI, neural network and/or user) is delayed in attending the second virtual meeting.

In general, notification delivery component 204 can determine whether notification 126 (e.g., the step-up notification or the meeting reminder) is accepted by the end entity (e.g., hardware, software, machine, AI, neural network and/or user). If yes, then notification delivery component 204 can automatically transfer the end entity (e.g., hardware, software, machine, AI, neural network and/or user) from the first virtual meeting to the second virtual meeting and inform attendees of the first virtual meeting that the end entity (e.g., hardware, software, machine, AI, neural network and/or user) has exited the first virtual meeting. If not, notification delivery component 204 can inform attendees of the second virtual meeting about the meeting conflict or delay experienced by the end entity (e.g., hardware, software, machine, AI, neural network and/or user).

In one or more embodiments, feedback component 210 can prompt the end entity (e.g., hardware, software, machine, AI, neural network and/or user) to provide manual feedback employable by computation component 202 (e.g., via NLU classification component 206) to enhance current state criticality score 132 and future state criticality score 134.

Additional embodiments of the present disclosure are described in greater detail with reference to the subsequent drawings.

FIG. 2 illustrates another block diagram of an example, non-limiting system 200 that can interpret the criticality of a virtual meeting and generate an optimal notification to a participant of the virtual meeting, in accordance with one or more embodiments described herein. Repetitive description of like elements and/or processes employed in respective embodiments is omitted for sake of brevity.

Non-limiting system 200 illustrates the system of smart call-ranking and notification model 110. As described with reference to FIG. 1, smart call-ranking and notification model 110 can comprise computation component 202, notification delivery component 204, NLU classification component 206, user engagement component 208 and feedback component 210.

In one or more embodiments, smart call-ranking and notification model 110 can be a software application that can interact (e.g., communicatively, operatively, electrically and/or via like function) with a video-conferencing software application. For example, a computing system (e.g., an operating system) running on a computing device (e.g., a desktop computer, a laptop, a smartphone, etc.) can comprise a videoconferencing software application that can connect to sensors (e.g., microphones, webcams, speakers, etc.) employed by the computing device and leverage device data (e.g., calendar data, email data, microphone data, webcam data, data from other applications, etc.) to allow an end entity (e.g., hardware, software, machine, AI, neural network and/or user) to conduct virtual meetings via the videoconferencing software application.

In one or more embodiments, the end entity (e.g., hardware, software, machine, AI, neural network and/or user) can install smart call-ranking and notification model 110 as a software application within the computing system. In an embodiment, the videoconferencing software application can interact with smart call-ranking and notification model 110 and support the dynamic notification functionality of smart call-ranking and notification model 110 described with reference to FIG. 1. In another embodiment, the end entity (e.g., hardware, software, machine, AI, neural network and/or user) can install a software update in the computing system, wherein the software update can enable the video-conferencing software application to interact with smart call-ranking and notification model 110 and to support the dynamic notification functionality of smart call-ranking and notification model 110.

Upon installing smart call-ranking and notification model 110 and/or the software update, the end entity (e.g., hardware, software, machine, AI, neural network and/or user) can select an option/opt in (e.g., via the UI of the computing device) to allow smart call-ranking and notification model 110 to leverage the device data (e.g., calendar data, email data, microphone data, webcam data, data from other applications, etc.) to perform the one or more operations described with reference to at least FIG. 1, and the end entity (e.g., hardware, software, machine, AI, neural network and/or user) can configure notification delivery preferences related to notification 126.

In one or more embodiments, smart call-ranking and notification model 110 can employ computation component 202 to compute current state criticality score 132 (e.g., a score from 0-100) and future state criticality score 134 (e.g., a score from 0-100) based on inputs from the device data (e.g., calendar data, email data, microphone data, webcam data, data from other applications, etc.). Current state criticality score 132 can be associated with a first virtual meeting, and future state criticality score 134 can be associated with a second virtual meeting, wherein the first virtual meeting and the second virtual meeting can be meetings that the end entity (e.g., hardware, software, machine, AI, neural network and/or user) can be scheduled to attend. Additionally, the second virtual meeting can be scheduled to begin prior to completion of the first virtual meeting or immediately after completion of the first virtual meeting. In one or more embodiments, smart call-ranking and notification model 110 can compute current state criticality score 132 and future state criticality score 134 prior to commencement of the first virtual meeting or during the first virtual meeting. In one or more embodiments, computation component 202 can employ NLU classification component 206 and/or user engagement component 208 to compute current state criticality score 132 and future state criticality score 134.

In one or more embodiments, NLU classification component 206 can parse (e.g., comb through) first meeting data 120 comprising historical meeting data, future meeting data (e.g., invites to virtual meetings), email data, and calendar data associated with the end entity (e.g., hardware, software, machine, AI, neural network and/or user) to evaluate the first virtual meeting and the second virtual meeting.

For example, based at least on the future meeting data, NLU classification component 206 can identify other end entities (e.g., hardware, software, machines, AI, neural networks and/or users) invited to the first virtual meeting and to the second virtual meeting (e.g., “Who are the individuals invited to the current meeting and to the next meeting?”) and further identify whether the second virtual meeting is with clients, peers and/or upper management (e.g., “Is this meeting with clients/peers/upper management?”) associated with the end entity (e.g., hardware, software, machine, AI, neural network and/or user). If the individuals invited to the second virtual meeting include the manager and a client of the end entity (e.g., hardware, software, machine, AI, neural network and/or user), NLU classification component 206 can assign/increase initial future state criticality score 124 (e.g., from 0 to 25).

NLU classification component 206 can further identify, based at least on the historical meeting data, whether the second virtual meeting is a reoccurring meeting (e.g., “Is this a reoccurring meeting?”) and the number of times the end entity (e.g., hardware, software, machine, AI, neural network and/or user) has attended the same type of meeting in the past X months (e.g., “How many times has the user attended this meeting in the last X months?”), wherein X can be a positive value. If the second virtual meeting is a reoccurring meeting that the end entity (e.g., hardware, software, machine, AI, neural network and/or user) has attended only once in the past month, NLU classification component 206 can assign/decrease initial future state criticality score 124 (e.g., from 25 to 20).

NLU classification component 206 can further identify, based at least on the calendar data, the host of the first virtual meeting (e.g., “Who is the host of the meeting?”). If the end entity (e.g., hardware, software, machine, AI, neural network and/or user) is the host of the first virtual meeting, NLU classification component 206 can assign/increase initial current state criticality score 122 (e.g., from 0 to 40).

Additionally, or alternatively, NLU classification component 206 can determine/identify/detect other relevant information based on first meeting data 120 to assign initial current state criticality score 122 to the first virtual meeting and to assign initial future state criticality score 124 to the second virtual meeting.

For example, NLU classification component 206 can identify, based at least on the email data, action items assigned to the end entity (e.g., hardware, software, machine, AI, neural network and/or user) (e.g., “Are there action items assigned to the user?”) by performing attachment scanning to scan attachments within emails accessible from an email inbox of the end entity (e.g., hardware, software, machine, AI, neural network and/or user).

NLU classification component 206 can further identify, based at least on the email data, the number of emails exchanged between participants of the first virtual meeting and/or the second virtual meeting (e.g., “How many emails have been exchanged between the participants prior to the meetings?”) and a level of activity of the end entity (e.g., hardware, software, machine, AI, neural network and/or user) within the email exchanges (e.g., “How active is the user in these email exchanges?”).

Similarly, in one or more embodiments, user engagement component 208 can parse (e.g., comb through) second meeting data 130 comprising historical meeting data, audio data (e.g., microphone data), visual data (e.g., webcam data) and UI data associated with the end entity (e.g., hardware, software, machine, AI, neural network and/or user) to analyze activities of the end entity (e.g., hardware, software, machine, AI, neural network and/or user).

For example, user engagement component 208 can identify, based on the audio data, the frequency of communication of the end entity (e.g., hardware, software, machine, AI, neural network and/or user) during the first virtual meeting (e.g., “How often is the user speaking in the meeting?”), whether there are multiple end entities (e.g., hardware, software, machines, AI, neural networks and/or users) participating in the first virtual meeting (e.g., “Are there multiple individuals participating in the conference?”), the length of time that a microphone employed by the end entity (e.g., hardware, software, machine, AI, neural network and/or user) to participate in the first virtual meeting has been muted in relation to the length of the meeting (e.g., “How long has the user's microphone been on mute in relation to the meeting time?”), and so on.

User engagement component 208 can further identify, based on the UI data, whether the end entity (e.g., hardware, software, machine, AI, neural network and/or user) has been screen-sharing (e.g., “Is the user screen-sharing?”), whether the end entity (e.g., hardware, software, machine, AI, neural network and/or user) is engaging with other software applications (e.g., “Is the user engaging with other applications?”), whether another end entity (e.g., hardware, software, machine, AI, neural network and/or user) is attempting to join the second virtual meeting (e.g., “Is there an attendee waiting in the meeting room?”), and so on.

User engagement component 208 can further identify, based on the webcam data, whether the end entity (e.g., hardware, software, machine, AI, neural network and/or user) is actively looking at the screen of the computing device to participate in the first virtual meeting (e.g., “Is the user actively looking at the screen/meeting?”). and so on.

Based on an analysis of actions of the end entity (e.g., hardware, software, machine, AI, neural network and/or user) during the first virtual meeting, user engagement component 208 can update (e.g., increase or decrease) initial current state criticality score 122 and update (e.g., increase or decrease) initial future state criticality score 124, wherein updating initial current state criticality score 122 can generate current state criticality score 132, and wherein updating initial future state criticality score 124 can generate future state criticality score 134.

In some embodiments, user engagement component 208 can determine, based on analysis of activities of the end entity (e.g., hardware, software, machine, AI, neural network and/or user), that initial current state criticality score 122 and initial future state criticality score 124 do not need to be updated. In such embodiments, initial current state criticality score 122 and initial future state criticality score 124 can be equal to current state criticality score 132 and future state criticality score 134, respectively.

As described with reference to FIG. 1, in one or more embodiments, notification delivery component 204 can generate notification 126 to notify the end entity (e.g., hardware, software, machine, AI, neural network and/or user) about the second virtual meeting. For example, the second virtual meeting can commence prior to completion of the first virtual meeting. If current state criticality score 132 is greater than future state criticality score 134, notification delivery component 204 can deliver a non-obtrusive meeting reminder (e.g., a pop-up on the corner of a desktop screen, a phone vibration, etc.) to the end entity (e.g., hardware, software, machine, AI, neural network and/or user), whereas if current state criticality score 132 is less than future state criticality score 134, notification delivery component 204 can initiate a step-up notification (e.g., automatically transferring a user from the first virtual meeting to the second virtual meeting, initiating a phone call/sending a text reminder to the user for the second virtual meeting, generating a full-screen pop-up notification, etc.) to alert the end entity about the second virtual meeting (e.g., hardware, software, machine, AI, neural network and/or user).

In one or more embodiments, if the end entity (e.g., hardware, software, machine, AI, neural network and/or user) transitions, based on notification 126, from the first virtual meeting to the second virtual meeting, notification delivery component 204 can notify attendees of the first virtual meeting that the end entity (e.g., hardware, software, machine, AI, neural network and/or user) has exited the first virtual meeting. Likewise, if the end entity (e.g., hardware, software, machine, AI, neural network and/or user) does not transition from the first virtual meeting to the second virtual meeting after viewing/accessing notification 126, notification delivery component 204 can notify attendees of the second virtual meeting the end entity (e.g., hardware, software, machine, AI, neural network and/or user) will be late to the second virtual meeting. Such embodiment can eliminate the waiting time spent by an end entity (e.g., hardware, software, machine, AI, neural network and/or user) in a virtual meeting to identify an opportunity to exit a meeting or to inform attendees of the virtual meeting about the exit, via chat.

In one or more embodiments, feedback component 210 can record subsequent actions of the end entity (e.g., hardware, software, machine, AI, neural network and/or user) as positive or negative feedback. In one or more embodiments, the positive feedback or the negative feedback can be recorded within notification delivery component 204. That is, the positive feedback or the negative feedback can be made available to notification delivery component 204. For example, the step-up notification can automatically transfer the end entity (e.g., hardware, software, machine, AI, neural network and/or user) from the first virtual meeting to the second virtual meeting and provide an option on the UI of the computing device, wherein the option can be employed by the end entity (e.g., hardware, software, machine, AI, neural network and/or user) to accept or decline the transfer. If the end entity (e.g., hardware, software, machine, AI, neural network and/or user) accepts the transfer (e.g., notification delivery) and transitions from the first virtual meeting to the second virtual meeting, feedback component 210 can record a positive feedback. On the contrary, if the end entity (e.g., hardware, software, machine, AI, neural network and/or user) declines the transfer and re-join the first virtual meeting, feedback component 210 can record a negative feedback.

Based on the feedback, feedback component 210 can update (e.g., reinforce or readjust) the weight allocations employed by NLU classification component 206 and user engagement component 208, respectively, to compute current state criticality score 132 and future state criticality score 134. For example, if the feedback is a positive feedback, feedback component 210 can reinforce the weight allocations employed by NLU classification component 206 and user engagement component 208, respectively, to compute current state criticality score 132 and future state criticality score 134. Alternatively, if the feedback is a negative feedback, feedback component 210 can readjust the weight allocations employed by NLU classification component 206 and user engagement component 208, respectively, to compute current state criticality score 132 and future state criticality score 134. In one or more embodiments, feedback component 210 can prompt the end entity (e.g., hardware, software, machine, AI, neural network and/or user) to provide manual feedback (e.g., via the UI of the computing device) that can be analyzed via NLU classification component 206 to further enhance the calculations of current state criticality score 132 and future state criticality score 134.

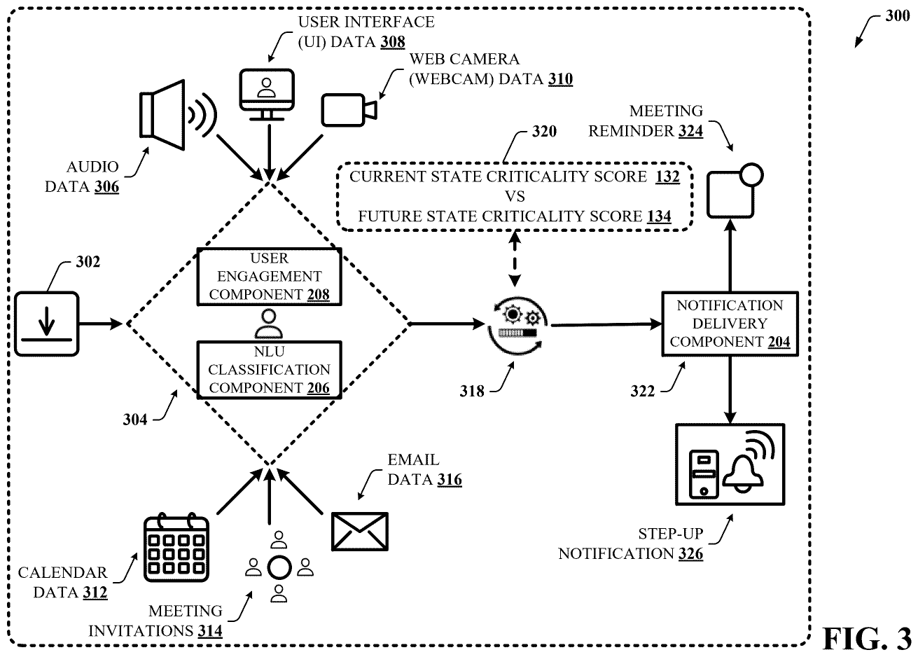

FIG. 3 illustrates a flow diagram of an example, non-limiting method 300 that can interpret the criticality of a virtual meeting and generate an optimal notification to a participant of the virtual meeting, in accordance with one or more embodiments described herein. Repetitive description of like elements and/or processes employed in respective embodiments is omitted for sake of brevity.

With continued reference to FIGS. 1 and 2, non-limiting method 300 can be employed by smart call-ranking and notification model 110 to assist an end entity (e.g., hardware, software, machine, AI, neural network and/or user) in prioritizing virtual meetings.

For example, at 302 in non-limiting method 300, a user can install smart call-ranking and notification model 110 as a software application within a computing system (e.g., an operating system) of a computing device (e.g., a desktop computer, a laptop computer, a smartphone, etc.).

At 304 in non-limiting method 300, NLU classification component 206 and user engagement component 208 can access data device data (e.g., calendar data, email data, microphone data, webcam data, data from other applications, etc.) associated with the user. For example, NLU classification component 206 can access calendar data 312, meeting invitations 314 and email data 316 associated with the user, and user engagement component 208 can access audio data 306, UI data 308 and webcam data 310.

At 318 in non-limiting method 300, NLU classification component 206 and user engagement component 208 can compute criticality scores based on the device data accessed at 304, as illustrated by block 320. For example, NLU classification component 206 can compute initial current state criticality score 122 by employing priority weighting in connection with an on-going virtual meeting (e.g., a first virtual meeting) that the user can be actively involved in, and NLU classification component 206 can compute initial future state criticality score 124 by employing priority weighting in connection with an upcoming virtual meeting (e.g., a second virtual meeting) that the user can be scheduled to attend. Thereafter, user engagement component 208 can update initial current state criticality score 122 by employing priority weighting in connection with the on-going virtual meeting to generate current state criticality score 132, and user engagement component 208 can update initial future state criticality score 124 by employing priority weighting in connection with the upcoming virtual meeting to generate future state criticality score 134.

At 322 in non-limiting method 300, notification delivery component 204 can determine and generate, based on current state criticality score 132 and future state criticality score 134, an optimal notification (i.e., notification 126) to alert the user about the second virtual meeting. For example, notification delivery component 204 can generate meeting reminder 324 (e.g., a pop-up on the corner of a desktop screen, a phone vibration, etc.) if current state criticality score 132 is greater than future state criticality score 134. Alternatively, notification delivery component 204 can initiate step-up notification 326 (e.g., automatically transferring a user from the first virtual meeting to the second virtual meeting, initiating a phone call or sending a text reminder about the second virtual meeting to the user, generating a full-screen pop-up notification, etc.) if current state criticality score 132 is less than future state criticality score 134.

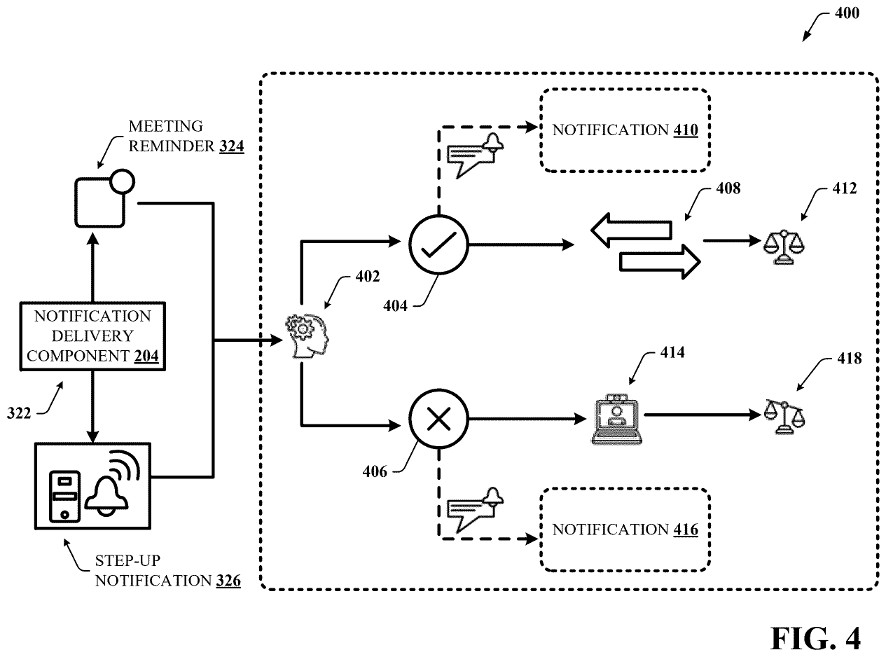

FIG. 4 illustrates a flow diagram of an example, non-limiting method 400 that can employ feedback, based on the responses of a participant of a virtual meeting to a notification, to more accurately interpret the criticality of a future virtual meeting, in accordance with one or more embodiments described herein. Repetitive description of like elements and/or processes employed in respective embodiments is omitted for sake of brevity.

With continued reference to at least FIG. 3, non-limiting method 400 can be employed by smart call-ranking and notification model 110 to record feedback and execute additional operations based on the user's response to notification 126.

At 402 in non-limiting method 400, feedback component 210 can record subsequent actions of the user, wherein the subsequent actions can be recorded within (e.g., made available to) notification delivery component 204. For example, at 404 in non-limiting method 400, upon receiving notification 126, the user can transition from the first virtual meeting to the second virtual meeting, and feedback component 210 can record the user's transition as a positive feedback within notification delivery component 204. Alternatively, at 406 in non-limiting method 400, upon receiving notification 126, the user can dismiss notification 126 (e.g., via the UI of the computing device) and continue to participate in the first virtual meeting.

If at 404 in non-limiting method 400, the user transitions to the second virtual meeting based on notification 126, then at 408 in non-limiting method 400, notification delivery component 204 can automatically transfer the user to the second virtual meeting. Additionally, notification delivery component 204 can generate notification 410 informing attendees of the first virtual meeting that the user has transitioned to the second virtual meeting due to a meeting conflict.

If at 406 in non-limiting method 400, the user dismisses notification 126, then at 414 in non-limiting method 400, notification delivery component 204 can proceed without transitioning the user to the second virtual meeting, and the user can continue participating in the first virtual meeting. Additionally, notification delivery component 204 can generate notification 416 informing attendees of the second virtual meeting that the user will be late to the second virtual meeting due to a meeting conflict.

If at 404 in non-limiting method 400, the user transitions to the second virtual meeting based on notification 126, then at 412 in non-limiting method 400, feedback component 210 can employ the positive feedback recorded at 404 to reinforce the weight allocations employed by NLU classification component 206 and user engagement component 208 to compute current state criticality score 132 and future state criticality score 134.

If at 404 in non-limiting method 400, the user dismisses notification 126, then at 418 in non-limiting method 400, feedback component 210 can employ the negative feedback recorded at 406 to readjust the weight allocations employed by NLU classification component 206 and user engagement component 208 to compute current state criticality score 132 and future state criticality score 134.

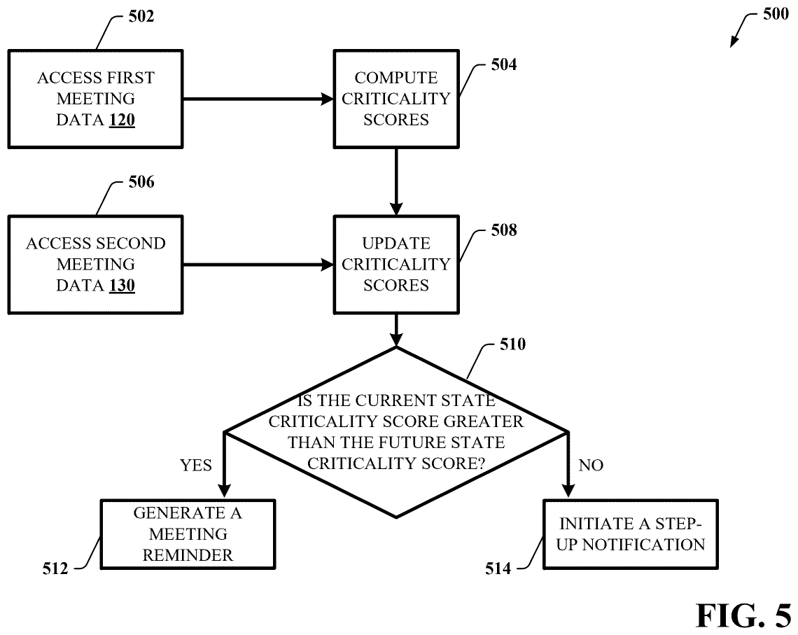

FIG. 5 illustrates a flow diagram of an example, non-limiting method 500 that can interpret the criticality of a virtual meeting and generate an optimal notification to a participant of the virtual meeting, in accordance with one or more embodiments described herein. Repetitive description of like elements and/or processes employed in respective embodiments is omitted for sake of brevity.

With continued reference to FIG. 4, non-limiting method 500 can be employed by smart call-ranking and notification model 110 to assist the end entity (e.g., hardware, software, machine, AI, neural network and/or user) in prioritizing virtual meetings. For example, in one or more embodiments, the user can be a consultant at an organization. Due to unforeseen circumstances (e.g., natural calamities, pandemics, etc.), the user's job can be primarily virtual, wherein a majority of the user's workdays can consist of virtual meetings and client calls (e.g., from 9:00 am to 5:00 pm). Sometimes, the virtual meetings and/or client calls can be scheduled back-to-back or overlap, making it challenging for the user to manage time. For example, on a given Monday morning, the user can be scheduled to attend a team daily stand-up meeting that can be the first call of the day. Thereafter, the user can be scheduled to attend the second call of the day which can be a high-priority meeting demanding timely attendance from the user. However, the team daily stand-up meeting (i.e., the first call) can end up running longer than planned, or the high-priority meeting (i.e., the second call) can be scheduled to begin prior to completion of the team daily stand-up meeting, thereby causing the first call to interfere with the second call.

At 502 in non-limiting method 500, NLU classification component 206 can access first meeting data 120 in connection with the first call and the second call.

At 504 in non-limiting method 500, NLU classification component 206 can compute initial current state criticality score 122 and initial future state criticality score 124.

At 506 in non-limiting method 500, user engagement component 208 can access second meeting data 130 in connection with the first call and the second call.

At 508 in non-limiting method 500, user engagement component 208 can update initial current state criticality score 122 and initial future state criticality score 124 to generate current state criticality score 132 and future state criticality score 134, respectively.

In one or more embodiments, user engagement component 208 can compute, based on second meeting data 130, a second current state criticality score and a second future state criticality score, wherein the second current state criticality score can be associated with the first call, and wherein the second future state criticality score can be associated with the second call. For example, the second current state criticality score can be indicative of the priority of the first call for the user, and the second future state criticality score can be indicative of the priority of the second call for the user. In one or more embodiments, computation component 202 can combine initial current state criticality score 122 with the second current state criticality score and generate current state criticality score 132, and computation component 202 can combine initial future state criticality score 124 with the second future state criticality score and generate future state criticality score 134.

At 510 in non-limiting method 500, notification delivery component 204 can determine whether current state criticality score 132 is greater than future state criticality score 134. If yes, then at 512 in non-limiting method 500, notification delivery component 204 can generate a meeting reminder. If not, then at 514 in non-limiting method 500, notification delivery component 204 can initiate a step-up notification.

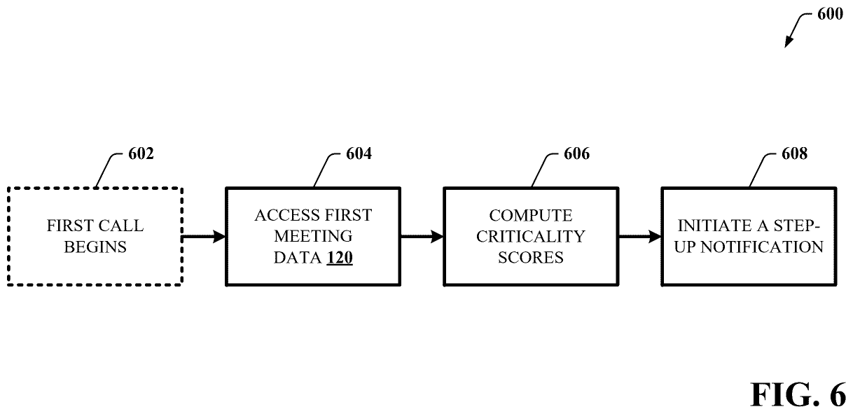

FIG. 6 illustrates a flow diagram of an example, non-limiting method 600 that can interpret the priority of a virtual meeting and initiate a step-up notification, in accordance with one or more embodiments described herein. Repetitive description of like elements and/or processes employed in respective embodiments is omitted for sake of brevity.

With continued reference to FIG. 5, non-limiting method 600 describes a scenario wherein NLU classification component 206 can compute current state criticality score 132 and future state criticality score 134.

For example, at 602 in non-limiting method 600, the first call can begin.

At 604 in non-limiting method 600, NLU classification component 206 can access first meeting data 120.

At 606 in non-limiting method 600, NLU classification component 206 can parse email data, calendar data and historical and future meeting data to determine that the user's second call is with senior management, occurs once a month with historically perfect attendance from the user and is responsible for a significant chain of email communication over the previous month, wherein the email communication includes an email discussing the user's role (e.g., presenting a report to attendees) in the second call. Accordingly, NLU classification component 206 can compute current state criticality score 132 and future state criticality score 134, wherein current state criticality score 132 can be associated with the first call, and wherein future state criticality score 134 can be associated with the second call. For example, NLU classification component 206 can increase current state criticality score 132 from 0 to 30 and increase future state criticality score 134 from 0 to 58.

At 608 in non-limiting method 600, notification delivery component 204 can initiate a step-up notification method (i.e., notification 126) that can display a full-screen pop-up notification request to automatically transfer the user from the first call to the second call. The user can accept the notification request, notification delivery component 204 can transfer the user from the first call to the second call, and feedback component 210 can record the user's acceptance of the notification request as positive feedback within notification delivery component 204.

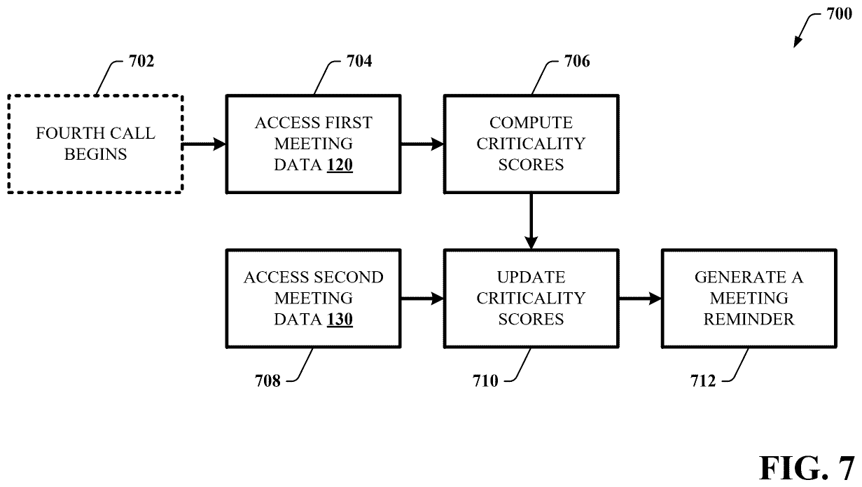

FIG. 7 illustrates a flow diagram of an example, non-limiting method 700 that can interpret the criticality of a virtual meeting and generate a meeting reminder, in accordance with one or more embodiments described herein. Repetitive description of like elements and/or processes employed in respective embodiments is omitted for sake of brevity.

With continued reference to FIG. 5, non-limiting method 700 can be employed by smart call-ranking and notification model 110 to continue to assist the end entity (e.g., hardware, software, machine, AI, neural network and/or user) in prioritizing virtual meetings. For example, the user can be additionally scheduled to attend a client call after the high-priority meeting and a townhall meeting thereafter on the same Monday. For example, the client call can be the third call of the day, and the townhall meeting can be the fourth call of the day.

At 702 in non-limiting method 700, the fourth call can begin while the user is engaged with the third call.

At 704 in non-limiting method 700, NLU classification component 206 can access first meeting data 120 and determine that the user is the host of the third call and there are more than fifty (50+) attendees in the fourth meeting.

At 706 in non-limiting method 700, based on the determination made by NLU classification component 206 at 704, NLU classification component 206 can compute initial current state criticality score 122 and initial future state criticality score 124. For example, NLU classification component 206 can increase initial current state criticality score 122 from 50 to 55 and decrease initial future state criticality score 124 from 50 to 45. For example, computation component 202 can automatically assign a score of 50 as initial current state criticality score 122 to the third call and a score of 50 as initial future state criticality score 124 to the fourth call, and NLU classification component 206 can recompute initial current state criticality score 122 and initial future state criticality score 124 based on analysis of first meeting data 120.

At 708 in non-limiting method 700, user engagement component 208 can access second meeting data 130 and monitor audio data, webcam data and UI data associated with the third call and with townhall meetings attended by the user in the past. Based on the monitoring, user engagement component 208 can determine that the user is screensharing a document within the third call. Additionally, user engagement component 208 can determine that during townhall meetings such as the fourth call, the microphone on the computing device employed by the user to participate in the townhall meetings is typically muted throughout the meetings, the user is often multi-tasking on different applications, and the user is sometimes distracted, not paying attention, or looking away throughout the meetings.

It should be noted that steps 704 and 708 of non-limiting method 700 can occur fairly simultaneously, one after another or in any other suitable order. That is, steps 704 and 708 of non-limiting method 700 can occur in one or more orders and/or concurrently.

At 710 in non-limiting method 700, based on the determinations made by user engagement component 208 at 708, user engagement component 208 can update initial current state criticality score 122 and initial future state criticality score 124. For example, user engagement component 208 can increase initial current state criticality score 122 from 55 to 60 and decrease initial future state criticality score 124 from 45 to 40. The updated score of 60 can be current state criticality score 132, and the updated score of 40 can be future state criticality score 134.

At 712 in non-limiting method 700, based on current state criticality score 132 being greater than future state criticality score 134, notification delivery component 204 can display a non-obtrusive pop-up banner (i.e., notification 126) in the top corner of the screen of the computing device employed by the user to remind the user about the fourth call. In response to the non-obtrusive banner, the user can conclude the third call and join the fourth call.

Thus, smart call-ranking and notification model 110 can continuously monitor data associated with an end entity (e.g., hardware, software, machine, AI, neural network and/or user) to assist the end entity (e.g., hardware, software, machine, AI, neural network and/or user) in prioritizing virtual meetings. Additionally, smart call-ranking and notification model 110 can provide a productive and efficient solution to the end entity (e.g., hardware, software, machine, AI, neural network and/or user), wherein the end entity (e.g., hardware, software, machine, AI, neural network and/or user) can manage virtual meetings via seamless and prioritized virtual meeting transitions and experience less stress when participating in the virtual meetings.

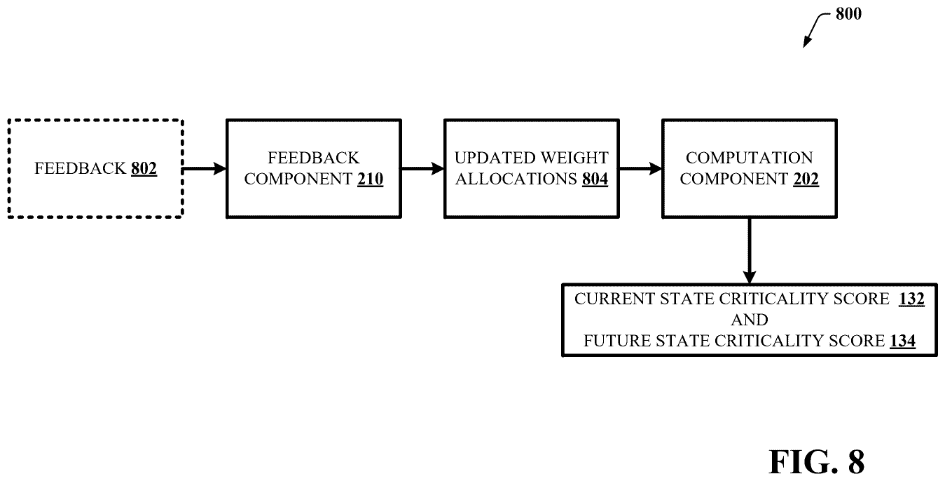

FIG. 8 illustrates a flow diagram of an example, non-limiting method 800 that can employ feedback to update weight allocations employable to compute respective criticality scores for respective virtual meetings, in accordance with one or more embodiments described herein. Repetitive description of like elements and/or processes employed in respective embodiments is omitted for sake of brevity.

As described with reference to FIG. 1, in one or more embodiments, notification 126 can alert an end entity (e.g., hardware, software, machine, AI, neural network and/or user) participating in a first virtual meeting about a second virtual meeting. Based on the response of the end entity (e.g., hardware, software, machine, AI, neural network and/or user) to notification 126, feedback component 210 can record feedback within notification delivery component 204 (i.e., communicate the feedback to notification delivery component 204), wherein the feedback can be a positive feedback or a negative feedback based on whether the end entity (e.g., hardware, software, machine, AI, neural network and/or user) transitions from the first virtual meeting to the second virtual meeting. For example, the feedback can be a positive feedback if the end entity (e.g., hardware, software, machine, AI, neural network and/or user) transitions from the first virtual meeting to the second virtual meeting based on notification 126, and the feedback can be a negative feedback if the end entity (e.g., hardware, software, machine, AI, neural network and/or user) ignores notification 126 and does not transition from the first virtual meeting to the second virtual meeting.

In one or more embodiments, feedback component 210 can also prompt the end entity (e.g., hardware, software, machine, AI, neural network and/or user) to provide manual feedback employable by computation component 202 (e.g., via NLU classification component 206 and/or user engagement component 208) to enhance current state criticality score 132 and future state criticality score 134. For example, the manual feedback can indicate whether notification 126 was accurate, and the manual feedback can be analyzed by computation component 202 via NLU classification component 206 and/or user engagement component 208 to further enhance the calculations of current state criticality score 132 and future state criticality score 134.

Accordingly, in one or more embodiments, feedback 802 can comprise the feedback recorded by feedback component 210 based on the response of the end entity (e.g., hardware, software, machine, AI, neural network and/or user) to notification 126 and/or comprise the manual feedback provided by the end entity (e.g., hardware, software, machine, AI, neural network and/or user). Based on feedback 802, feedback component 210 can update (e.g., reinforce or readjust) respective weight allocations. For example, feedback component 210 can analyze feedback 802 by employing machine learning models (e.g., to detect patterns, trends, etc.) and employ weighting algorithms that can evaluate the factors having the most positive or negative impact. Weight adjustment algorithms can adjust weight allocations by employing reinforcement learning or gradient descent optimization.

In one or more embodiments, feedback component 210 can continuously update the weight allocations based on new feedback and implement a feedback loop based on which computation component 202 can learn over time. For example, updating the respective weight allocations can generate updated weight allocations 804. In one or more embodiments, updated weight allocations 804 can be employed by computation component 202 to compute current state criticality score 132 and future state criticality score 134 for future virtual meetings (e.g., a third virtual meeting, a fourth virtual meeting, and so on).

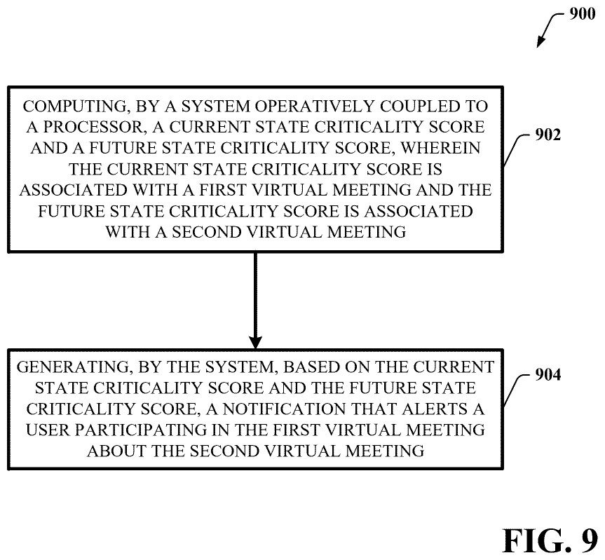

FIG. 9 illustrates a flow diagram of an example, non-limiting method 900 that can interpret the criticality of a virtual meeting and generate an optimal notification to a participant of the virtual meeting, in accordance with one or more embodiments described herein. Repetitive description of like elements and/or processes employed in respective embodiments is omitted for sake of brevity.

At 902, non-limiting method 900 can comprise computing (e.g., by computation component 202), by a system operatively coupled to a processor, a current state criticality score and a future state criticality score, wherein the current state criticality score is associated with a first virtual meeting and the future state criticality score is associated with a second virtual meeting.

At 904, non-limiting method 900 can comprise generating (e.g., by notification delivery component 204), by the system, based on the current state criticality score and the future state criticality score, a notification that alerts a user participating in the first virtual meeting about the second virtual meeting.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

FIG. 10 illustrates a block diagram of an example, non-limiting, operating environment 1000 in which one or more embodiments described herein can be facilitated. FIG. 10 and the following discussion are intended to provide a general description of a suitable operating environment 1000 in which one or more embodiments described herein at FIG. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as smart call-ranking and notification code 1028. In addition to block 1028, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1028, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer-readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1028 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 1028 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer-readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

CLOUD COMPUTING SERVICES AND/OR MICROSERVICES (not separately shown in FIG. 10): private and public clouds 1006 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components;
a processor that executes the computer-executable components stored in the memory, wherein the computer-executable components comprise:
a computation component that computes a current state criticality score and a future state criticality score, wherein the current state criticality score is associated with a first virtual meeting and the future state criticality score is associated with a second virtual meeting; and
a notification delivery component that generates, based on the current state criticality score and the future state criticality score, a notification that alerts a user participating in the first virtual meeting about the second virtual meeting.

2. The system of claim 1, wherein the second virtual meeting is scheduled to begin prior to completion of the first virtual meeting or immediately after completion of the first virtual meeting, and wherein the notification is employable by the user to determine whether to prioritize the second virtual meeting over the first virtual meeting.

3. The system of claim 1, wherein computing the current state criticality score and the future state criticality score comprises:
accessing, by a Natural Language Understanding (NLU) classification component, first meeting data comprising historical meeting data, future meeting data, email data, and calendar data associated with the user;
analyzing, by the NLU classification component, the first meeting data; and
computing, by the NLU classification component, based on analysis of the first meeting data, an initial current state criticality score and an initial future state criticality score, wherein the initial current state criticality score is associated with the first virtual meeting, and wherein the initial future state criticality score is associated with the second virtual meeting.

4. The system of claim 3, wherein the computing the current state criticality score and the future state criticality score further comprises:
accessing, by a user engagement component, second meeting data comprising the historical meeting data, audio data, visual data and user interface (UI) data associated with the user;
analyzing, by the user engagement component, the second meeting data; and
updating, by the user engagement component, based on analysis of the second meeting data, the initial current state criticality score and the initial future state criticality score, wherein updating the initial current state criticality score generates the current state criticality score, and wherein updating the initial future state criticality score generates the future state criticality score.

5. The system of claim 1, wherein generating the notification comprises:
comparing, by the notification delivery component, the current state criticality score with the future state criticality score; and
generating, by the notification delivery component, a meeting reminder if the current state criticality score is greater than the future state criticality score, wherein the meeting reminder informs the user about the second virtual meeting.

6. The system of claim 1, wherein generating the notification comprises:
comparing, by the notification delivery component, the current state criticality score with the future state criticality score; and
initiating, by the notification delivery component, a step-up notification if the current state criticality score is less than the future state criticality score, wherein the step-up notification allows the user to accept or decline an automatic transition from the first virtual meeting to the second virtual meeting.

7. The system of claim 6, further comprising:
a feedback component that updates the current state criticality score and the future state criticality score, based on whether the user accepts or declines the automatic transition, wherein updating the current state criticality score and the future state criticality score comprises:
recording, by the feedback component, feedback, wherein the feedback is recorded as a positive feedback if the user accepts the automatic transition, and wherein the feedback is recorded as a negative feedback if the user declines the automatic transition; and
updating, by the feedback component, respective weight allocations employable by the computation component to compute the current state criticality score and the future state criticality score, based on the feedback.

8. The system of claim 7, wherein the feedback component prompts the user to provide manual feedback employable by the computation component to enhance the current state criticality score and the future state criticality score.

9. The system of claim 6, wherein the notification delivery component notifies attendees of the first virtual meeting, in response to the user accepting the automatic transition, that the user has exited from the first virtual meeting.

10. The system of claim 6, wherein the notification delivery component notifies attendees of the second virtual meeting, in response to the user declining the automatic transition, that the user is delayed in attending the second virtual meeting.

11. A computer-implemented method, comprising:
computing, by a system operatively coupled to a processor, a current state criticality score and a future state criticality score, wherein the current state criticality score is associated with a first virtual meeting and the future state criticality score is associated with a second virtual meeting; and
generating, by the system, based on the current state criticality score and the future state criticality score, a notification that alerts a user participating in the first virtual meeting about the second virtual meeting.

12. The computer-implemented method of claim 11, wherein the second virtual meeting is scheduled to begin prior to completion of the first virtual meeting or immediately after completion of the first virtual meeting, and wherein the notification is employable by the user to determine whether to prioritize the second virtual meeting over the first virtual meeting.

13. The computer-implemented method of claim 11, wherein the computing comprises:
accessing, by the system, first meeting data comprising historical meeting data, future meeting data, email data, and calendar data associated with the user;
analyzing, by the system, the first meeting data; and
computing, by the system, based on analysis of the first meeting data, an initial current state criticality score and an initial future state criticality score, wherein the initial current state criticality score is associated with the first virtual meeting, and wherein the initial future state criticality score is associated with the second virtual meeting.

14. The computer-implemented method of claim 13, wherein the computing further comprises:
accessing, by the system, second meeting data comprising the historical meeting data, audio data, visual data and UI data associated with the user;
analyzing, by the system, the second meeting data; and
updating, by the system, based on analysis of the second meeting data, the initial current state criticality score and the initial future state criticality score, wherein the updating the initial current state criticality score generates the current state criticality score, and wherein the updating the initial future state criticality score generates the future state criticality score.

15. The computer-implemented method of claim 11, wherein the generating comprises:
comparing, by the system, the current state criticality score with the future state criticality score; and
generating, by the system, a meeting reminder if the current state criticality score is greater than the future state criticality score, wherein the meeting reminder informs the user about the second virtual meeting.

16. The computer-implemented method of claim 11, wherein the generating further comprises:
comparing, by the system, the current state criticality score with the future state criticality score; and
initiating, by the system, a step-up notification if the current state criticality score is less than the future state criticality score, wherein the step-up notification allows the user to accept or decline an automatic transition from the first virtual meeting to the second virtual meeting.

17. The computer-implemented method of claim 15, further comprising:
updating, by the system, the current state criticality score and the future state criticality score, based on whether the user transitions from the first virtual meeting to the second virtual meeting upon receiving the meeting reminder, wherein the updating comprises:
recording, by the system, feedback, wherein the feedback is recorded as a positive feedback if the user transitions from the first virtual meeting to the second virtual meeting, and wherein the feedback is recorded as a negative feedback if the user does not transition from the first virtual meeting to the second virtual meeting; and
updating, by the system, respective weight allocations employable by the system to compute the current state criticality score and the future state criticality score, based on the feedback.

18. The computer-implemented method of claim 11, further comprising:
prompting, by the system, the user to provide manual feedback that is employable by the system to enhance the current state criticality score and the future state criticality score.

19. A computer program product for determining priorities of virtual meetings, the computer program product comprising a computer readable storage medium having program instructions embodied therewith, the program instructions executable by a processor to cause the processor to:
compute, by the processor, a current state criticality score and a future state criticality score, wherein the current state criticality score is associated with a first virtual meeting and the future state criticality score is associated with a second virtual meeting; and
generate, by the processor, based on the current state criticality score and the future state criticality score, a notification that alerts a user participating in the first virtual meeting about the second virtual meeting.

20. The computer program product of claim 19, wherein the program instructions are further executable by the processor to cause the processor to:
access, by the processor, first meeting data comprising historical meeting data, future meeting data, email data, and calendar data associated with the user;
analyze, by the processor, the first meeting data;
compute, by the processor, based on analysis of the first meeting data, an initial current state criticality score and an initial future state criticality score, wherein the initial current state criticality score is associated with the first virtual meeting, and wherein the initial future state criticality score is associated with the second virtual meeting;
access, by the processor, second meeting data comprising the historical meeting data, audio data, visual data and UI data associated with the user;
analyze, by the processor, the second meeting data; and
update, by the processor, based on analysis of the second meeting data, the initial current state criticality score and the initial future state criticality score, wherein updating the initial current state criticality score generates the current state criticality score, and wherein updating the initial future state criticality score generates the future state criticality score.
